(19) United States
(12) Patent Application Publication
(10) Pub. No.: US 2017/0176302 A1
(43) Pub. Date: Jun. 22, 2017

(54) APPARATUS AND METHODS FOR SAMPLE HANDLING AND PROCESSING

(71) Applicants: Jane P. BEARINGER, Berwyn, PA (US); Scott CASTANON, Carlsbad, CA (US)

(72) Inventors: Jane P. BEARINGER, Berwyn, PA (US); Scott CASTANON, Carlsbad, CA (US)

(21) Appl. No.: 14/971,947

(22) Filed: Dec. 16, 2015

(51) Int. Cl. G01N 1/38; G01N 1/14; B01L 3/00

(52) U.S. Cl. CPC G01N 1/38; B01L 3/502715; B01L 3/527; G01N 1/14; B01L 2300/0627; B01L 2300/0861; B01L 2300/0672; B01L 2200/16; B01L 2300/0838; B01L 2300/16; G01N 2001/149

(57) ABSTRACT

An apparatus for sample handling and processing is disclosed. The apparatus can comprise a sample collector, a reagent reservoir configured to hold a reagent, and a separator disposed between the reagent reservoir and the sample collector. The apparatus can comprise an actuator being movable from a start position to a dispense position to modify the separator to open a fluid flow path from the reagent reservoir to the sample collector and dispense the sample and the reagent through the sample collector. A method of sample handling and processing is also disclosed. The method can comprise collecting a sample, moving an actuator to modify a separator sealing a reagent reservoir to open a flow path from the reagent reservoir to the sample collector and dispense the sample and the reagent through the sample collector. A system for sample handling, processing and detecting is further disclosed.

INCORPORATION BY REFERENCE

All publications and patent applications mentioned in this specification are incorporated herein by reference in their entirety to the same extent as if each individual publication or patent application was specifically and individually indicated to be incorporated by reference.

### FIELD

Various embodiments of the disclosure relate generally to apparatus and methods for sample handling and processing. Specifically, the disclosure relates to apparatus and methods for handling and processing biological samples for nucleic acid amplification and detection.

### BACKGROUND

Sample analysis is valuable in medical diagnosis, clinical research, agricultural development and environmental control. Proper sample handling and processing is important to obtain accurate diagnostic and analytical results. Improper sample handling and processing, such as sample contamination by the ambient environment, inaccurately dispensing of reagent, failing to follow operating procedure, etc., may result in inaccurate test results, even misdiagnosis and mistreatment. However, proper sample handling and processing is challenging in Point-of-Care situations, especially in remote areas and developing countries.

For example, Polymerase Chain Reaction (PCR) has found wide spread applications in a variety of medical diagnosis. Though PCR is considered the gold standard in diagnostic tests, PCR systems are expensive and require a high level of technical expertise. Loop-mediated Isothermal Amplification (LAMP) is a fast, sensitive, specific and cost-effective nucleic acid amplification method. LAMP uses 4-6 different primers specifically designed to recognize 6 distinct regions of a target gene. Incubating sample, primers, DNA polymerase and dye affords amplification and detection of target DNA/genes isothermally between 60-65° C. LAMP provides very high amplification efficiency, producing orders of magnitude more DNA than PCR. Furthermore, LAMP' s single temperature process does not need expensive instrumentation, which is necessary in PCR's thermocycling process. Notably, LAMP has been observed to be more tolerant than PCR of inhibitors in complex samples, such as blood or culture media. Due to the reduced instrumentation needs of LAMP compared to PCR, and the tolerance towards inhibitors LAMP is increasingly used in Point-of-Care (POC) assays. In the field, LAMP can outperform traditional PCR and grant results comparable to laboratory-based nested-PCR.

However, only few apparatus are available for field-based LAMP or other molecular diagnostic systems. In general, these apparatus are still expensive and impractical. For example, disposable flip-cap reaction tubes encasing lyophilized reagents are used in sample preparation for LAMP. During the standard operation procedure, the operator needs to remove a necessary quantity of flip-cap tubes from an aluminum foil pouch before use. The operator has to process the DNA samples with other proper amount of reagents. Then the operator has to dispense an accurate amount of the mixture into the opened flip-cap tubes. Thus, all reagents at one point in time are open to the ambient environment and subject to the possibility of being contaminated. Furthermore, this is a time consuming and labor intensive process requiring pipetting. Because unpredictable environmental conditions, limited resources and shortage of well-trained operators at the Point-of-Care locations, improper sample handling and processing may occur and compromise the test results.

There have been some efforts to develop disposable cartridges for LAMP application at the Point-of-Care locations. These efforts are still using the conventional sample collecting and processing methods, however, thus subjecting the sample to contamination from ambient environment. Moreover, some of these proposed efforts also have other problems such as complicated fabrication, high cost and not being practical to operate in the field.

Similar problems exist for samples handling and processing in the field in general. There is a pressing need for a practical and inexpensive apparatus that can perform fully enclosed sample collecting, handling and processing in Point-of-Care locations. There is also a need for an efficient and easy -to-operate method for sample handling and processing that can eliminate pipetting and dispense accurate amount of reagents to reduce the chance of ambient environment contamination and the possibility of operator's error to increase test efficiency and accuracy in the field.

### SUMMARY OF THE DISCLOSURE

The present disclosure relates to apparatus and methods for sample handling and processing. Specifically, the disclosure relates to apparatus and methods for sample handling and processing for Point-of-Care LAMP application. The sample handling and processing apparatus disclosed herein can collect a sample, process the sample with a reagent disposed inside a reagent reservoir within the apparatus, and dispense a mixture of the sample and the reagent to a test apparatus. The disclosure further discloses a method of sample handling, processing and delivering to a test apparatus. The disclosure also discloses an integrated and enclosed system for sample handling, processing and detecting.

Various embodiments of the disclosure disclose a sample handling and processing apparatus. The apparatus can be a single instrument that can dispense sample and one or more reagents into a test apparatus. The one or more reagents can be stored separately within the apparatus in a secure manner minimizing contamination. The apparatus can comprise an actuator such that movement of the actuator can modify the one or more reagent reservoirs to open fluid flow paths. The apparatus can comprise a sample collector disposed downstream of the one or more reagent reservoirs. The sample collector can comprise a collection medium such as a capillary tube, a hard sponge, etc. The apparatus can further comprise a mixing chamber in some embodiments. The mixing chamber can be disposed upstream of the sample collector. The mixing chamber can receive and mix the one or more reagents. The apparatus can comprise or lock a connector that can attach the apparatus to the test apparatus.

Specifically, the sample handling and processing apparatus can be used with a test cassette in LAMP application. The apparatus can collect and process a sample, dispense the sample and other necessary solutions, into a detection cassette such as a LAMP cassette or other test apparatus. The apparatus can handle most sample matrices including urine, blood, cerebrospinal fluid, etc. Approximately 1-100 microliters of the sample matrix can be added to reagents or solutions, such as buffer, water, dyes, etc. The sample matrix and the reagents or solutions can be mixed in the apparatus in some embodiments. In some other embodiments, the sample matrix and the reagents or solutions can be mixed in the test apparatus, for example, in a nucleic acid amplification cassette or cartridge. The cassette can comprise a plurality of discrete and isolated chambers, thus enabling multiplexed LAMP reactions. The sample handling and processing apparatus and the test cassette can form an integrated, enclosed and efficient system for sample collection, preparation and detection in LAMP field application. The sample is enclosed in the apparatus after being collected, thus preventing contamination from ambient environment. The accurate amount of reagent or reagents for preparing the sample is pre-loaded or pre-filled in the reagent reservoir or reservoirs disposed within the apparatus. The apparatus mitigates the need to expose reagents to the environment, as well as the need to pipetting.

Various embodiments disclose an apparatus for sample handling and processing. The apparatus can comprise a sample collector configured to receive a sample, a reagent reservoir configured to hold a reagent, where the reagent reservoir is disposed upstream of the sample collector. The apparatus can further comprise a separator disposed between the reagent reservoir and the sample collector, sealing the reagent from contamination from ambient environment. The apparatus can comprise an actuator being movable from a start position to a dispense position to modify the separator to open a fluid flow path from the reagent reservoir to the sample collector and dispense the sample and the reagent through the sample collector. The reagent from the reagent reservoir can flush the sample out of the sample collector. The apparatus can dispense the sample and the reagent into a test apparatus.

In some embodiments, the apparatus can comprise a dispenser. The reagent reservoir can be disposed within the dispenser. The actuator can be partially disposed within the dispenser and movable along a side surface of the dispenser axially. The sample collector can be disposed on a distal end of the dispenser in some embodiments. In some other embodiments, the sample collector can be a snap-on piece and attached to the dispenser. In some alternative embodiments, the sample collector can be a separate piece, which can be connected to the dispenser and the test apparatus. In yet some other embodiments, the sample collector can be disposed within the test apparatus. The sample collector can comprise a collection medium. The collection medium can include a sponge, a capillary tube, a swab, etc. The apparatus can further comprise a connector, which can be configured to attach the apparatus to the test apparatus.

In some embodiments, the reagent reservoir can be disposed in a recessed space within the actuator. The apparatus can further comprise a puncturing component. The puncturing component can be sized and shaped to match a size and shape of the reagent reservoir such that the reagent can be completely forced out of the reagent reservoir. In some embodiments, the separator can be a foil sheet. Movement of the actuator can cause the foil sheet to be punctured and a fluid flow path can be opened.

In some embodiments, the apparatus can further comprise a mixing chamber disposed downstream of the sample collector to mix the sample and the reagent, wherein the actuator being movable from the dispense position to a deliver position to deliver a mixture of the sample and the reagent from the mixing chamber into the test apparatus. For example, the apparatus can further comprise an adapter, where the mixing chamber is disposed within the adapter. The adapter can be attached to the dispenser or integrated into the dispenser. In some other embodiments, the apparatus can dispense the sample and the reagent into the test apparatus directly, while the sample and the reagent can be mixed in a mixing chamber disposed within the test apparatus. In yet some other embodiments, the mixing chamber can be disposed within the sample collector. In some alternative embodiments, the mixing chamber can be disposed within the collector. In still some other embodiments, the flushing action can create sufficient mixing and a separate mixing chamber is not necessary.

In some embodiments, the apparatus can comprise a bypass channel. The separator can comprise a sliding plug, where the sliding plug is disposed above a top end of the bypass channel. The movement of the actuator can move the sliding plug down to reach the top end of the bypass channel, and open a fluid path from the reagent reservoir to the sample collector.

In some embodiments, the reagent reservoir can comprise a side blister. In some other embodiments, the reagent reservoir can comprise an inline blister. In some alternative embodiments, the reagent reservoir can comprise a pre-filled chamber.

In some embodiments, the apparatus can comprise a plurality of reagent reservoirs with a plurality of reagents. The apparatus can comprise a plurality of separators. The apparatus can further comprise a plurality of actuators as well.

In some embodiments, the apparatus can comprise an elution chamber disposed downstream of the plurality of reagent reservoirs and upstream of the sample collector. The plurality of reagents can be mixed in the elution chamber before being pushed through the sample connector.

Various embodiments disclose a method of sample handling and processing. The method can comprise collecting a sample using a sample collector. The sample collector can be disposed within a dispenser in some embodiments. The sample collector can be a snap-on piece and attached to the dispenser in some other embodiments. The dispenser can contain a reagent in a reagent reservoir. The method can comprise moving an actuator to modify a separator sealing the reagent reservoir from ambient environment and to open a flow path from the reagent reservoir to the sample collector. The method can further comprise moving the actuator to dispensing the sample and the reagent through the sample collector. The movement of the actuator can push the reagent to flush the sample out of the sample collector. The actuator can dispense the sample and the reagent to the cassette or the test apparatus.

In some embodiments, the method further comprise mixing the sample with the reagent in a mixing chamber and deliver a mixture of the sample and the reagent into the test apparatus. In some embodiments, the mixing chamber is disposed within an adapter which can be attached to the dispenser. In some other embodiments, the mixing chamber can be disposed within the cassette or the test apparatus.

Various embodiments further disclose a system for sample handling, processing and detecting. The system can comprise the sample handling and processing apparatus. The apparatus can comprise a reagent reservoir configured to hold a reagent. The reagent reservoir can be disposed upstream of a sample collector. The apparatus can comprise a separator disposed between the reagent reservoir and the sample collector, sealing the reagent from contamination from ambient environment. The apparatus can further comprise an actuator being movable from a start position to a dispense position to modify the separator to open a fluid flow path from the reagent reservoir to the sample collector and dispense a sample and the reagent through the sample collector into a cassette or a test apparatus. The apparatus can also comprise a connector configured to mate with the test apparatus. The system can comprise a sample collector configured to receive the sample. The sample collector can be integrated with the apparatus in some embodiments. The sample collector can be integrated with the cassette or test apparatus in some other embodiments. The system can further comprise the cassette or test apparatus. The cassette or test apparatus can comprise an inlet to receive the sample and the reagent. The cassette can comprise a detection chamber and a microfluidic channel configured to transport the sample and the reagent into the detection chamber. The detection chamber can be pre-loaded with nucleic acid amplification reagents. In some embodiments, the cassette can comprise multiple discrete, isolated detection chambers pre-loaded with multiple nucleic acid amplification reagents, thus enabling multiplexing nucleic acid amplification detection.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 schematically illustrates a perspective view of a sample handling and processing apparatus according to one embodiment of the disclosure.

FIG. 2 schematically illustrates a section view of the sample handling and processing apparatus when an actuator is in a start position.

FIG. 3 schematically illustrates a perspective view of a sample collector disposed on a distal end of a dispenser of the sample handling and processing apparatus.

FIG. 4 schematically illustrates a section view of the sample handling and processing apparatus when the actuator is in an opening position.

FIG. 5 schematically illustrates a section view of the sample handling and processing apparatus when the actuator is in a flush position.

FIG. 6A schematically illustrates an enclosed system 500 for sample handling, processing and detection.

FIG. 6B schematically illustrates the wells or chambers of a LAMP cassette or cartridge upon fill at commencement of heating.

FIG. 6C schematically illustrates that target material was present and amplified in the left 2 chambers (purple to blue transition) after heating.

FIG. 7A schematically illustrates a perspective view of a sample handling and processing apparatus comprising a slide plug and a bypass channel for a urine sample according to another embodiment of the disclosure.

FIG. 7B schematically illustrates a section view of the sample handling and processing apparatus in FIG. 7A when an actuator is in a start position.

FIG. 7C schematically illustrates a section view of the sample handling and processing apparatus in FIG. 7A when the actuator is in a dispense position.

FIG. 7D schematically illustrates a section view of the sample handling and processing apparatus in FIG. 7A when the actuator is in a deliver position.

FIG. 8A schematically illustrates a perspective view of a sample handling and processing apparatus comprising a slide plug and a bypass channel for a blood sample according to yet another embodiment of the disclosure.

FIG. 8B schematically illustrates a section view of the sample handling and processing apparatus in FIG. 8A when an actuator is in a start position.

FIG. 8C schematically illustrates a section view of the sample handling and processing apparatus in FIG. 8A when the actuator is in a dispense position.

FIG. 8D schematically illustrates a section view of the sample handling and processing apparatus in FIG. 8A when the actuator is in a deliver position.

FIG. 9A schematically illustrates a perspective view of a sample handling and processing apparatus comprising side blister reservoirs according to another alternative embodiment of the disclosure.

FIG. 9B schematically illustrates a section view of the sample handling and processing apparatus comprising side blister reservoirs.

FIG. 9C schematically illustrates a section view of the sample handling and processing apparatus in FIG. 9A in a start position.

FIG. 9D schematically illustrates a section view of the sample handling and processing apparatus in FIG. 9A when side blister reservoirs are being pressed down.

FIG. 9E schematically illustrates a section view of the sample handling and processing apparatus in FIG. 9A when a plunger is being unlocked by twisting the plunger.

FIG. 9F schematically illustrates a section view of the sample handling and processing apparatus in FIG. 9A in a dispense position.

FIG. 10A schematically illustrates a perspective view of a sample handling and processing apparatus comprising inline blisters according to yet another embodiments of the disclosure.

FIG. 10B schematically illustrates an exploded view of the sample handling and processing apparatus comprising inline blisters in FIG. 10A.

FIG. 10C schematically illustrates a section view of the sample handling and processing apparatus comprising inline blisters in FIG. 10A.

FIG. 10D schematically illustrates a section view of the sample handling and processing apparatus in FIG. 10A in a start position.

FIG. 10E schematically illustrates a section view of the sample handling and processing apparatus in FIG. 10A when a sample collector is attached to a dispenser.

FIG. 10F schematically illustrates a section view of the sample handling and processing apparatus in FIG. 10A in a dispense position.

FIG. 10G schematically illustrates a section view of the sample handling and processing apparatus in FIG. 10A in a deliver position.

FIG. 11A schematically illustrates a perspective view of the sample handling and processing apparatus comprising a plunger according to another embodiments of the disclosure.

FIG. 11B schematically illustrates an exploded view of the sample handling and processing apparatus comprising a plunger in FIG. 11A.

FIG. 11C schematically illustrates a section view of the sample handling and processing apparatus comprising a plunger in FIG. 11A.

FIG. 11D schematically illustrates a section view of the sample handling and processing apparatus in FIG. 11A in a start position.

FIG. 11E schematically illustrates a section view of the sample handling and processing apparatus in FIG. 11A in a dispense position.

FIG. 12 is a block diagram of a method of sample handling and processing.

### DETAILED DESCRIPTION

The present disclosure relates to apparatus and methods for sample handling and processing. The sample handling and processing apparatus can collect a sample, process the sample with a reagent which is disposed inside a reagent reservoir within the apparatus, and dispense a mixture of the sample and the reagent to a test cassette or other test apparatus. The disclosure further discloses a method of sample handling, processing and delivering to a test apparatus. The disclosure also relates to a fully integrated and enclosed system for sample handling, processing and detecting.

The sample handling and processing apparatus disclosed herein can be a single instrument that can dispense sample and one or more reagents including buffer and dye through a port into a test apparatus. The apparatus can comprise one or more reagent reservoirs, for example, reservoirs for dye and buffer in LAMP application. The one or more reagents, for example, dye and buffer, can be stored separately within the apparatus in a secure manner minimizing contamination. The apparatus can comprise an actuator such that a movement of the actuator can dispense the one or more reagents as well as the sample. The actuator can modify the one or more reagent reservoirs to open a fluid flow path. For example, the actuator can move axially to puncture the one or more reagent reservoirs in some embodiments. In some other embodiments, the one or more reagents can have separate dispensing actuators. For example, dye and buffer can be stored as separate blister packs and each blister pack can have separate actuators. The apparatus can comprise a sample collector disposed downstream of the one or more reagents. The sample collector can comprise, for example, a capillary tube or a hard sponge.

The apparatus can further comprise a mixing chamber in some embodiments. The mixing chamber can be disposed upstream of the sample collector. The mixing chamber can receive and mix the one or more reagents, such as buffer and dye. The apparatus can comprise a connector that can attach the apparatus to a cassette or other test apparatus.

The sample handling and processing apparatus can collect, process and dispense a sample and other necessary solutions, into a detection cassette such as a LAMP cassette or other test apparatus. The sample handling and processing apparatus can handle most sample matrices including urine, blood, cerebrospinal fluid, etc. Approximately 1-100 microliters of the sample matrix can be added to reagents or solutions, such as buffer, water, dyes, etc. The sample matrix and the reagents or solutions may be mixed in the sample handling and processing apparatus in some embodiments. In some other embodiments, the sample matrix and the reagents or solutions may be mixed in a test apparatus, for example, in a nucleic acid amplification cassette or cartridge or device.

The sample handling and processing apparatus is a fully integrated and enclosed apparatus. The sample is enclosed in the apparatus after being collected, thus preventing contamination from ambient environment. The accurate amount of reagent or reagents for preparing the sample is pre-loaded or pre-filled in the reagent reservoir or reservoirs disposed inside the apparatus. The operator in the field can simply make one or two movements to open the sealing of the reservoir or reservoirs, for example, by moving the actuator axially. The apparatus is easy to use, eliminating pipetting and possible dispensing errors associated with pipetting. The operator only needs little training to operate the apparatus properly.

One of the important components of fielding an assay is incorporating the chemistry into a practical apparatus. The sample handling and processing apparatus integrates a sample collector with pre-filled reagent reservoirs. The apparatus comprises one or more reagent reservoirs with pre-filled accurate amounts of reagents. The apparatus adds the sample to necessary reagents for preparing the sample, such as buffers, dyes, etc. The sample can be prepared efficiently and accurately. The single apparatus can collect and prepare the sample. The apparatus mitigates the need to expose reagents to the environment, as well as the need to pipetting. The apparatus can prevent contamination from ambient environment, reduce the possibility of operator's errors and provides accurate and efficient sample handling and processing. The apparatus can be inexpensive, efficient, and practical for field applications.

Specifically, the sample handling and processing apparatus can be used with a test cassette in LAMP application. The cassette can comprise a plurality of discrete and isolated chambers, thus enabling multiplexed LAMP reactions. The sample handling and processing apparatus and the test cassette can form an integrated, enclosed and efficient system for sample collection, preparation and detection in LAMP field application. The system can replace the conventional flip-cap tubes, mitigate the need to expose the reagent to the environment and eliminate pipetting. The system can provide easy, accurate and efficient sample preparation for LAMP reactions, thus facilitating the applications of LAMP techniques in Point-Of-Care locations.

The sample handling and processing apparatus can comprise a sample collector. The sample collector can be disposed at a distal end of a dispenser in some embodiments. The sample collector can collect blood, urine, or any other samples. The apparatus can comprise one or more reagent reservoirs upstream of the sample collector. The apparatus can further comprise an actuator. When the actuator is actuated, the one or more reagent reservoirs can be opened. The one or more reagents can flow out of the reagents reservoirs. The operator can invert the apparatus to ensure fully mixing of the one or more reagents, but this step is not necessary. The one or more reagents can flush out the sample from the sample collector. In some embodiments, the apparatus can further comprise a mixing chamber downstream of the sample collector such that the sample and the one or more reagents can be fully mixed. In yet some other embodiments, some reagents can flow into the mixing chamber through bypass channels or be deposited onto the surface of the mixing chamber. The operator can also invert the apparatus to ensure fully mixing of the sample and the one or more reagents, but this step is not necessary as well. The apparatus can further comprise a connector, which is configured to mate to a cassette or other test apparatus. The operator can attach the apparatus to the cassette or other test apparatus through the connector.

The actuator can have a start position when the one or more reagents are stored in the one or more reagent reservoirs separately and sealed from ambient environment. The actuator can be moved to an open position to modify the one or more reagent reservoirs and open a fluid flow path from the reagent reservoirs to the sample collector. The actuator can be moved to a dispense position when the one or more reagents are pushed to flush the sample out of the sample collector. In some embodiments, the apparatus further comprises a mixing chamber downstream of the sample collector. The actuator can have a deliver position to deliver the mixture of the sample and the one or more reagents through the sample collector into a cassette or other test apparatus. However, the operator can dispense the sample along with the one or more reagents into the cassette directly without the mixing chamber. The operator can move the actuator step by step, from the start position, to the open position, and to the dispense position. In some embodiments, the operator can further move the actuator from the dispense position to the deliver position. The operator can also combine the steps, from the start position to the dispense position directly, or just push down to go through the open position to the dispense position to the deliver position in one movement.

In some other embodiments, the mixing chamber within the apparatus may not be necessary. The one or more reagents can flush the sample out of the sample collector by the actuator, the sample along with the one or more reagents can be dispensed into the cassette or other test apparatus directly. The operator can move the actuator from the start position to the open position to open the one or more reagent reservoir, to the dispense position to flush the sample and the one or more reagents out of the sample collector and dispense the mixture of the sample and the one or more reagents into the cassette or other test apparatus. The sample and the one or more reagents can be mixed within the cassette or other test apparatus. In some cases, the flushing action can sufficiently mix the sample and the one or more reagents, thus a separate mixing chamber is not necessary.

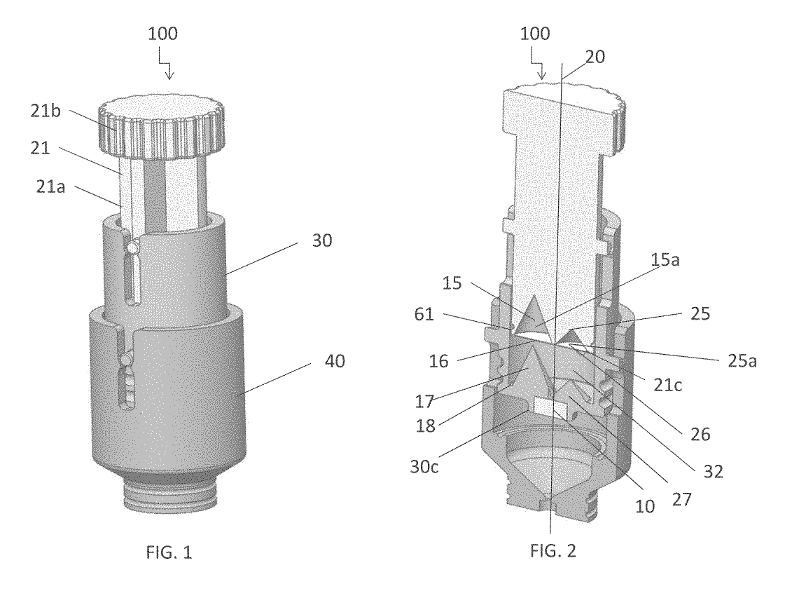

FIG. 1 schematically illustrates a perspective view of a sample handling and processing apparatus 100 according to one embodiment of the disclosure. FIG. 2 schematically illustrates a section view of the sample handling and processing apparatus 100. Referring to FIG. 1 and FIG. 2, the apparatus 100 can comprise an actuator 21, a dispenser 30. For example, the actuator 21 can comprise a plunger in some embodiments as shown in FIG. 1 and FIG.2. The actuator 21 can have a movable body 21a, a cap 21b and a bottom end 21c. The actuator 21 can fit tightly in the dispenser 30. For example, the dispenser 30 can be in a substantial hollow cylindrical shape. The dispenser 30 can have a shape similar to a cup in some embodiments. The dispenser 30 can have other shapes as well. The actuator 21 can slide back and forth along inside the dispenser axially. The axial direction is defined as the direction of a central axis 20 of the dispenser 30 perpendicular to a distal end 30c. In some embodiments, the actuator 21 can slide back and forth along inside the dispenser longitudinally. The bottom end 21c of the actuator 21 can make an airtight seal with the side surface of the dispenser 30 in some embodiments. In some other embodiments, there can be a small gap between the actuator 21 and the side surface of the dispenser 30 such that additional water or reagents can be added to the dispenser 30. The diameter of the cross section of the cap 21b can be larger than the diameter of the cross section of body 21a. The cross section of the body 21a can be in a circular or a cross or any other shape. The actuator 21 can be partially disposed in the dispenser 30 and movable with respect to the dispenser 30 axially or longitudinally. The actuator body 21a can be configured to match an inner side surface of the dispenser 30. For example, the outer diameter or the largest dimension of the cross section of the plunger body 21a can be configured to fit the inner diameter of the cross-section of the dispenser 30 such that the actuator body 21a can move axially along the inner side surface of the dispenser 30. The bottom end 21c of the actuator 21 can be configured to match a shape and size of the opening of the dispenser 30 such that the bottom 21c and the side surface of the dispenser form an airtight seal or only have a small gap. For example, the outer diameter of the bottom 21c matches the inner diameter of the cross-section of the dispenser 30. In some other embodiments, the actuator 21 can be a pump, a punch, a button, a door, a shutter, or any other actuation components. The dispenser 30 can have a distal end 30c and a sample collector 10 can be disposed at the distal end 30c.

In some embodiments, the sample handling and processing apparatus 100 can further comprise an adapter 40 configured to attach the dispenser 30 to a test apparatus. The adapter 40 can be a substantial cylindrical shape in some embodiments. The adapter 40 can have other shapes as well. The adapter 40 can be configured to have a size and shape that matches the size and shape of the dispenser 30. The apparatus 100 can have a double-cup configuration. The adapter 40 can be disposed partially around the dispenser 30. The outer side surface of the dispenser 30 can form an airtight seal with an inner side surface of the adapter 40. The dispenser 30 can be configured to match the opening of the adapter 40. For example, the outer diameter of the cross section of the dispenser 30 can be configured to match the inner diameter of cross-section the adapter 40 such that the dispenser 30 can move axially or longitudinally along an inner side surface of the adapter 40 and fit tightly with the adapter 40. The apparatus 100 can have a double-cup configuration. The plunger 21 can movably fit tightly inside the first cup, which is the dispenser 30. The dispenser 30 can movably fit tightly inside the second cup, which is the adapter 40. The adapter 40 can be configured to be detachable from and re-attachable to the dispenser 30. When the adapter 40 is removed from the dispenser 30, the distal end 30c of the dispenser 30 can be exposed such that the sample collector 10 can be exposed to collect a sample. After collecting the sample, the adapter 40 can be re-attached to the dispenser 30.

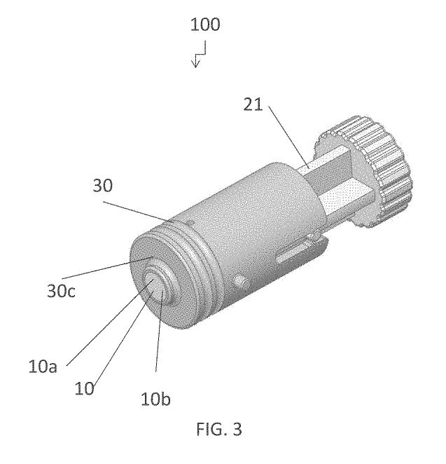

FIG. 3 schematically illustrates the sample handling and processing apparatus 100 with the distal end of the dispenser 30 exposed when the adapter 40 is removed. The apparatus 100 can comprise the sample collector 10. In some embodiments, the sample collector 10 can be disposed at a distal end of the dispenser 30 as shown in FIG. 3. For example, the sample collector 10 can be built into the dispenser 30. In some other embodiments, the sample collector 10 can comprise a click-on or snap-on piece (not shown) to attach onto the dispenser 30. In some alternative embodiments, the sample collector 10 can be a separate piece that is configured to be attached to the dispenser 30, and a cassette or cartridge. In yet some other embodiments, the sample collector 10 can be disposed into a cassette or cartridge. The sample collector 10 can be configured to collect a sample 10a. The sample 10a can include a variety of samples such as blood, urine, saliva, mucous, feces, semen, tissue, cells, food, liquids, solids, gases, etc. The sample collector 10 can comprise a collection medium 10b, such as absorbing sponges, porous materials, capillary tubes, pipets, swabs, etc. For example, the sample collector 10 can comprise a collection medium 10b comprising a porous material, for example, a hard sponge, to receive urine or other fluid sample 10a. Urine sample 10a can be collected by placing the hard sponge 10b into a urine collection cup. In some other embodiments, the sample collector 10 can comprise a collection medium 10b comprising a capillary tube, the capillary tube can be placed near a finger prick to collect a blood sample 10a.

The sample collector 10 can be fabricated from an inert polymer or plastic or metal or porous material, etc. The sample collector 10 may, for example, be fabricated from an inert polymer. Various sample matrices can include, but are not limited to, food, urine, saliva, mucous, feces, blood, semen, tissue, cells, DNA, RNA, protein, plant matter, animal matter, liquids, solutions, solids, gases, etc. The sample collector 10 may, for example, be dipped or placed into one or more sample matrices of interest. The sample collector 10 may also be placed in a person's mouth in order to collect a saliva sample. The sample matrices of interest may, for example, be placed or deposited onto the sample collector 10. The sample collector 10 can also be place closely to a site of finger prick to collect a controlled amount of blood sample.

Referring back FIG. 2, the sample handling and processing apparatus 100 can comprise a reagent reservoir 15 with a pre-filled reagent 15a. “Reagent” is defined broadly herein as a substance used in detecting or measuring a component because of its chemical or biological activity or inactivity. The reagent can comprise water, dye, TE buffer, isothermal buffer and/or other buffers or any other compositions or materials. In some other embodiments, the reagent can comprise enzyme and master mix as well. The apparatus 100 can comprise a separator 16. The separator 16 can be used to seal the reagent reservoir 15 and prevent the reagent 15a from being ambient environment contamination. The separator 16 can be disposed between the reagent reservoir 15 and the sample collector 10. The separator 16 can be configured to separate the reagent reservoir 15 and the sample collector 10. In some embodiments, the separator 16 can comprise a foil seal as shown in FIG. 2. The foil seal 16 can be punctured and broken with the movement of the actuator 21. In some other embodiments, the separator 16 can be a slide plug, a blister wrap, a valve or in other forms.

The actuator 21 can have a start position 61 when the actuator 21 is extending farthest from the distal end 30c of the dispenser 30 as shown in FIG. 2. The actuator 21 can have an open position (not shown) when the separator 16 of the reagent reservoir 15 is punctured or modified to open a fluid flow path such that the reagent 15a flows out of the reagent reservoir 15. For example, the reagent reservoir 15 can comprise a recessed space which can be disposed at the bottom end 21c within the actuator 21 in some embodiments. A corresponding puncturing component 17 can be disposed at the bottom surface 18 of the dispenser 30. In some other embodiments, the reagent reservoir 15 can be disposed at the bottom surface 18 of the dispenser 30 and the corresponding puncturing component 17 can be disposed at the bottom end 16 of the actuator 21. The puncturing component 17 can be a spike, a knife, a needle or any pointed component. When the actuator 21 is being pushed down from the start position to the open position, the puncturing component 17 can pierce the separator 16 of the reagent reservoir 15 and a fluid path from the reagent reservoir 15 to the sample collector 10 can be opened. The reagent 15a can flow out of the reagent reservoir 15. In some embodiments, the puncturing component 17 can have a same shape as the reagent reservoir 15 as shown in FIG. 2 to, e.g., assist movement of the reagent 15a out of the reagent reservoir 15.

Referring to FIG. 2, the apparatus 100 can further comprise a second reagent reservoir 25 holding a second reagent 25a. A second separator 26 can be used to seal the second reagent reservoir 26. A second puncturing component 27 can be disposed correspondingly to the location of the second reagent reservoir 26. The second reagent reservoir 25 can be disposed at the same surface perpendicular to the axial direction as the reagent reservoir 15. For example, both the reagent reservoir 15 and the second reagent reservoir 25 can be disposed at recessed spaces at the bottom surface 21c as shown in FIG. 2. In this parallel configuration, both the reagent reservoir 15 and the second reagent 25 can be punctured by the actuator 21 when the actuator 21 is being pushed down. In some other embodiments, the reagent reservoir 15 can be an inline chamber or blister disposed within the actuator 21 or the dispenser 30, and the second reagent reservoir 25 can be the other inline chamber or blister in serial with the reagent reservoir 15, disposed within the actuator 21 or the dispenser 30. In some embodiments, the apparatus 100 can further comprise a third reagent reservoir, a fourth reagent reservoir, or any number of reagent reservoirs depending on the needs. The apparatus can comprise a plurality of reagent reservoirs. When the plurality of reagent reservoirs are in serial configuration, the downstream reagent reservoirs can be configured to hold dry reagents as well.

In some embodiments, the apparatus 100 can further comprise an elution chamber 32 downstream of the reagent reservoirs 15, 25 and upstream of the sample collector 10. After the actuator 21 is being pushed down, the reagent reservoir 15 and the second reagent reservoir 25 are pierced. The reagent 15a and the second reagent 25a can flow out of the reagent reservoirs 15, 25 and to the elution chamber 32. The reagent 15a and the second reagent 25a can be mixed in the elution chamber 32. In some embodiments, a plurality of reagents can be mixed in the elution chamber 32. In some cases, the operator can invert the apparatus 100 to fully mix the plurality of reagents. However, this step is not necessary.

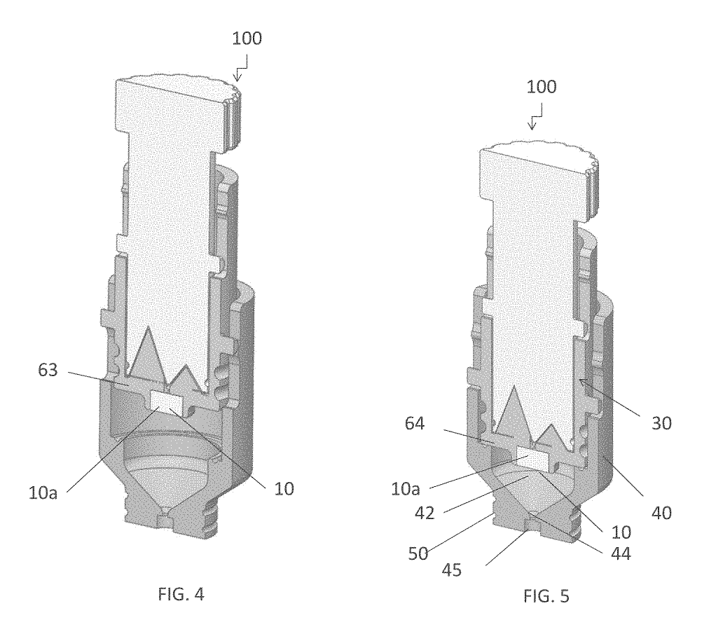

FIG. 4 schematically illustrates the sample handling and processing apparatus when the actuator 21 is in a dispense position 63. The one or more reagents can flow through the sample collector 10 and flush the sample 10a out of the sample collector 10. The one or more reagents can be flushed out of the sample collector 10 along with the sample when the actuator 21 is in the flush position. In some other embodiments, some reagents can bypass the sample collector 10. In yet some other embodiments, there can be a small gap between the inner side surface of the dispenser 30 and the outer side surface of the actuator 21. If the sample 10a is a very small amount, pure water can be added to the dispenser 30 through the small gap to flush the sample almost completely out of the sample collector 10 before pushing down the actuator 21. When the apparatus 100 is connected to the cassette or other test apparatus, the sample and the one or more reagents can be dispensed into the cassette or other test apparatus directly when the actuator is in the dispense position.

FIG. 5 schematically illustrates the sample handling and processing apparatus 100 when the actuator 21 is in a deliver position 64. In some embodiments, the apparatus 100 can further comprise the adapter 40 as discussed above. The apparatus 100 can further comprise a mixing chamber 42 disposed within the adapter 40 downstream of the sample collector 10. The sample and the one or more reagents can be mixed in the mixing chamber 42. In some embodiments, the adapter 40 can further comprise a seal 44 at an outlet 45. The operator can invert the apparatus 100 to fully mix the sample with the one or more reagents. Again, this step is not necessary. The mixing chamber 42 can further comprise a vent path to get rid of excessive gas. The mixing chamber 42 can ensure the fully mixing of the sample and the one or more reagents. In some other embodiments, the adapter 42 does not comprise a seal, but the cassette comprises a seal or a valve to prevent the mixture entering the cassette before actuation. When the actuator 21 is being pushed to the deliver position, which is an end of travel in some embodiments, the mixture of the sample 10a and the one or more reagents can be delivered from the apparatus 100 to the cassette. In some embodiments, the volume of the mixing chamber 42 can be configured to deliver a controlled amount of the mixture. The mixing chamber 42 can be both a mixing chamber and a metering chamber to deliver the controlled amount of mixture.

The apparatus 100 can comprise a connector 50 configured to attach the apparatus 100 to a cassette or other test apparatus as shown in FIG. 5. The connector 50 can be in a variety of mechanical forms. The connector 50 can be screwed onto the cassette or clicked onto the cassette. The fitting into the cassette can be luer lock, custom fit, snap lock, reversible, irreversible, etc. After the sample is collected by the sample collector 10, the apparatus 100 can be attached to the cassette by the connector 50 if inverting of the apparatus 100 is not necessary. In some cases, the operator can actuate the actuator 21 and open the one or more reagents reservoirs, then invert the apparatus 100 to fully mix the one or more reagents. The apparatus 100 can be attached to the cassette by the connector 50 afterwards. The connector 50 configured to attach the apparatus 100 to the cassette can be disposed on the adapter 40 as shown in FIG. 5. The connector 50 can also be disposed on the sample collector 10 in the case when there is no adapter in some other embodiments. The connector 50 can be disposed on the dispenser 30 in some alternative embodiments. The connector 50 can also be a separate piece that is configured to connect the apparatus 100 to the cassette or other test apparatus.

The movement of the actuator 21 can modify the reagent reservoirs 15, 25 and open the fluid flow path. The movement of the actuator 21 can push the one or more reagents 15a, 25a to flush the sample 10a out of the sample collector 10. The flushing action can help to mix the sample 10a and the one or more reagents 15a, 25a. The movement of the actuator 21 can also dispense the sample 10a and the one or more reagents 15a, 25a into the cassette or other test apparatus. The operator can actuate the actuator 21 from the start position 61, to the open position (not shown), and to the dispense position 63. In some embodiments, the operator can further move the actuator 21 from the dispense position 63 to the deliver position 64. The operator can actuate the actuator 21 step-by-step or combine the steps, from the start position 61 to the dispense position 63 directly, or just push down all the way to the deliver position 64 in a single movement.

The sample handling and processing apparatus 100 can be used as a pragmatic and practical apparatus in a variety of applications, specifically, in field-based molecular diagnostic applications. For example, the apparatus 100 can be used in the field LAMP applications. In some embodiments, the apparatus 100 can have a length from about 1 cm to about 30 cm. For example, the apparatus can have a length about 3 cm to 8 cm. The outer diameter of the apparatus can be from about 1 mm to about 30 mm. The inner diameter of the apparatus 100 can be from about 0.5 mm to about 20 mm. The actuator 21 can have a length about 1 cm to 20 cm, and a travel distance from about 2 cm to about 15 cm. For example, the apparatus can have a length from about 3 cm to about 8 cm, an outer diameter from about 5 mm to about 15 mm, and an inner diameter from about 2 mm to about 8 mm. The actuator can have a length from about 2 cm to 6 cm and a travel distance from about 2 cm to about 6 cm in some embodiments. Values outside the above ranges are also possible. The range of dimensions can be changed depending on the needs. Possible ranges are broad. The apparatus 100 can be of any workable aspect ratio and size based on the volumes of the sample 10a and the reagents 15a and 25a. The apparatus 100 can be made of plastic, metal, a composite, glass, etc. For example, the apparatus 100 can be made of polypropylene in some embodiments.

The apparatus 100 can comprise the reagent reservoir 15 for dye 15a and the second reservoir 25 for buffer 25a. The sample 10a can include, but is not limited to, urine, blood, saliva, mucous, feces, semen, tissue, food, etc. In LAMP, for example, the dye 15a can include, but is not limited to, Hydroxynaphthol naphthol blue, SYBR green, Calcein, FITC, picogreen, Syto 9 or any other dyes. The isothermal amplification buffers with MgSO4 can include, but is not limited to, TE, HEPEs or any other buffers. The apparatus 100 can further include other reagents such as Water, Glycerol, Betaine, etc.

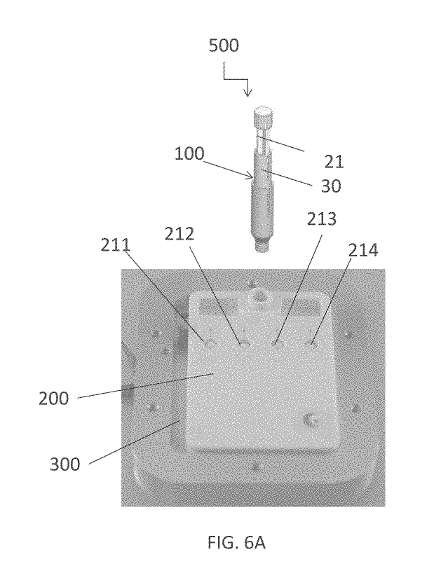

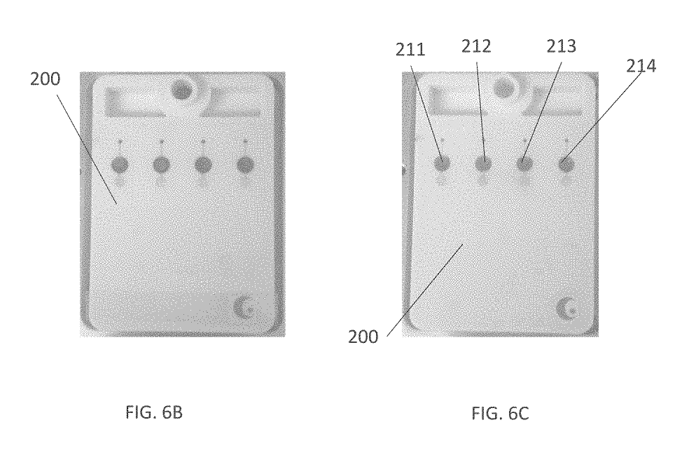

FIG. 6A schematically illustrates an enclosed system 500 comprising a sample handling and processing apparatus 100 and a test apparatus 200 for sample handling, processing and detecting. The apparatus 100 can be used with the test apparatus 200, such as a LAMP cassette or cartridge, forming the enclosed and integrated sample collecting, processing and detecting system. The test apparatus 200 can be a point-of-care nucleic acid amplification and detection apparatus described in U.S. patent application Ser. No. 14/262,683, titled “Methods and Apparatus for point-of-care Nucleic Acid Amplification and Detection”, which is incorporated herein by reference in its entirety.

The test apparatus 200 can comprise multiple discrete wells or chambers, for example, a 4-well cassette 200 comprising wells 211-214 is shown in FIG. 6A. The discrete wells or chambers 211-214 in the test apparatus or LAMP cassette or cartridge 200 can be pre-loaded with multiple different lyophilized nucleic acid amplification reagents. The test apparatus or LAMP cassette 200 can be resting in an aluminum heating nest 300. The apparatus 100 can add the sample 10a in buffer 25a and dye 15a to discrete, isolated wells or chambers 211-214 in the LAMP cassette or cartridge 200, enabling multiplexed LAMP reactions. The test apparatus or cassette 200 can comprise an inlet to receive the sample 10a the dye 15a and the buffer 25a. The test apparatus or LAMP cassette 200 can comprise a microfluidic channel configured to transport the sample 10a dye 15a and buffer 25a into the detection chambers or wells 211-214. In some embodiments, for a 4-well LAMP cassette 200, the apparatus 100 can dispense buffer 25a from about 25 microliters to about 300 microliters and dye 15a from about 5 microliters to about 100 microliters. For example, the apparatus 100 can dispense about 125 microliters buffer 25a and about 45 microliters dye 15a. Values outside the above range are also possible. The volume of buffer 25a and dye 15a can change depending on the needs.

For example, the apparatus 100 and the test apparatus or LAMP cassette or cartridge 200 can be used to detect drug-resistant strains of malaria, viruses such as Ebola, bacteria such as TB, etc. The system 500 can facilitates detection of any desired nucleic acid sequence by substituting appropriate primers in the master mix. The LAMP cassette or cartridge 200 can be filled with sample plus buffer. FIG. 6B schematically illustrates the wells or chambers 211-214 upon fill at commencement of heating. FIG. 6C schematically illustrates that target material was present and amplified in the left 2 chambers 211-212 (purple to blue transition) after heating.

Referring to FIGS. 1-6A, the sample handling and processing apparatus 100 can collect, dilute and deliver a sample 10a and other necessary reagents or solutions into the LAMP cassette 200. The apparatus 100 can handle most sample matrices including urine, blood, cerebrospinal fluid, etc. Approximately 1-100 microliters of the sample matrix can be added to the reagents or solutions, such as buffer, water, dyes, etc. The sample 10a and the reagents may be mixed in the apparatus 100 or in the LAMP cassette 200. The sample collector 10 can comprise a collection medium 10b, such as a hard sponge, a porous material, a capillary tube, a swabs, etc.

The sample handling and processing apparatus 100 can be configured for working with a urine sample matrix or a blood sample matrix. As discussed above, the reagents or solutions, such as dyes and buffers, can be contained in the recessed regions within the dispenser 30 or the actuator 21. In the field operation, the operator can collect sample 10a (urine) using the sample collector 10 located at the distal end of the dispenser 30. The operator can move the actuator 21 by pushing the plunger in some embodiments. Movement of the actuator 21 can release the buffer and dye stored inside the reagent reservoirs in the apparatus 100. If necessary, the operator can mix the buffer and dye by inverting the apparatus 100. The operator can connect the apparatus 100 to the cassette or cartridge 200. The connector 50 in various embodiments could be used to attach the apparatus 100 to cassette or cartridge 200. The operator can actuate the actuator 21 further and pass the buffer/dye mixture through the sample collector 10 so the urine is combined with the buffer/dye mixture. The LAMP cassette or cartridge 200 can further comprise an inverted funnel static mixer (not shown) to ensure mixing of the urine with the buffer/dye. The volume of buffer/dye dispensed in this step can be controlled to ensure sufficient volume to fill all the sample wells or chambers, for example, 4 wells in some embodiments or 8 wells in some other embodiments. The number of wells or the degree of multiplexing can be 2, 4, 6, 8, 10, 12, 20, 30, 40, 50 or any numbers therebetween. Numbers outside the above range are also possible. The number of wells or the degree of multiplexing can be varied depending on the needs.

The apparatus 100 can remain connected to the LAMP cassette or cartridge 200 during processing, or may be detached. The lyophilized reagents could be dried onto plastic in the dispenser 30 or onto the porous sample collector 10 in the flow path. However, dried reagents are not necessary; some assays may proceed with only liquid reagents stored in the apparatus 100 or in the LAMP cassette or cartridge 200.

The system 500 can handle a variety of samples. For example, the blood sample collector 10 may be in the form of porous material with a volume from about 2 microliters to about 100, or from about 5 microliters to about 25 microliters in some embodiments. Values outside the above range are also possible. The blood sample collector 10 can be in the form of microcapillary tubes for volumes of less than about, 1, 2, 3, 4, 5, 10, 15, 20, 30, 40, 50 microliters. For example, the microcapillary tube can have a volume from about 2 microliter to about 8 microliter in some embodiments. Values outside the above range are also possible. For small volumes, some pure water can be used to push the sample out of the capillary tube before the sample is exposed to the other liquid reagents, such as buffers, dyes, etc. The sample collector 10 can be disposed at the distal end of the dispenser 30 in some embodiments.

In some alternative embodiments, the sample collector can be disposed in the cassette or cartridge. The sample handling and processing apparatus can comprise one or more reagent reservoirs. The movement of the operator can open the one or more reagent reservoirs such that the one or more reagents can flow into the cassette or cartridge through the sample collector. The sample can be flushed into the cassette or cartridge along with the one or more reagents. The sample and the one or more reagents can be mixed inside the cassette or cartridge, for example, in an inverted funnel mixer, then flow into the reaction wells or chambers.

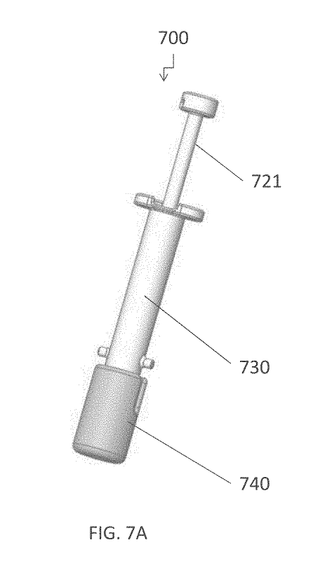

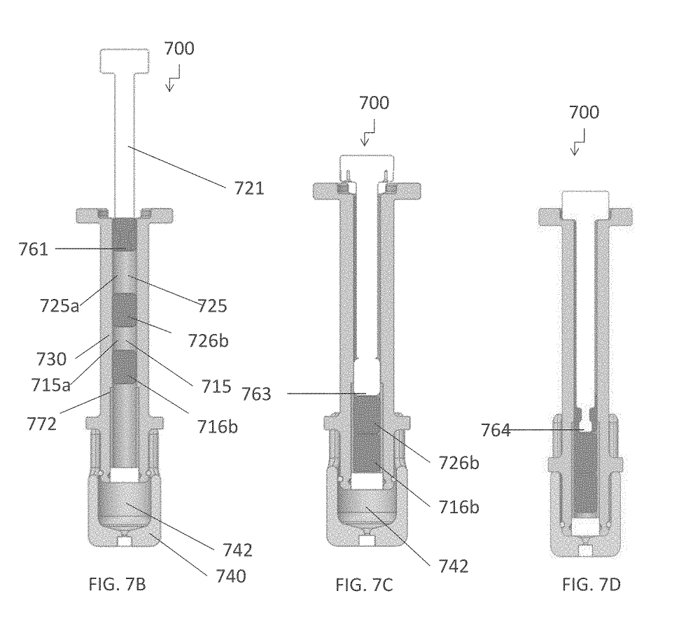

The sample handling and processing apparatus of this disclosure can have a variety of alternative embodiments. FIG. 7A schematically illustrates a perspective view of a sample handling and processing apparatus 700 according to another embodiment of the disclosure. FIGS. 7B-7D schematically illustrate section views of the sample handling and processing apparatus 700 when the actuator 721 is in a start position 761, a dispense position 763 and a deliver position 764 respectively.

Referring to FIGS. 7A-7D, the separator of the apparatus 700 can comprise one or more sliding plugs. For example, the separator can comprise a first sliding plug 716b and a second sliding plug 726b as shown in FIG. 7B. The first sliding plug 716b and the second sliding plug 726b can be disposed within the dispenser 730 in serial upstream of the sample collector (not shown). The first sliding plug 716b and the second sliding plug 726b can separate and seal the reagent 715a and the second reagent 725a from ambient environment contamination. The apparatus 700 can further comprise a bypass channel 772. When the actuator 721 is in the start position 761, both first sliding plug 716b and the second sliding plug 726b can be disposed above a top end of the bypass channel 772. The reagent 715a and the second reagent 725a can be stored separately within the dispenser 730 in a secured manner in the start position 761. When the actuator 721 is being pushed down to move or modify the first sliding plug 716b to pass the top end of the bypass channel 772, the reagent 715 can flow down through the bypass channel 772. The actuator 721 can open a fluid flow path from the reagent reservoir 715 to the sample collector 710. When the actuator 721 is being further pushed down to move or modify the second sliding plug 726b to pass the top end of the bypass channel 772, the second reagent 725 can flow down through the bypass channel 772 as well. The actuator 721 can open a fluid flow path from the second reagent reservoir 725 to the sample collector 710. When the actuator 721 is being pushed down to the dispense position 763 as shown in FIG. 7C, the reagent 715a and the second reagent 725a along with the sample can be flushed out of the sample collector 710. The sample, the reagent 715a and the second reagent 725a can be mixed in the mixing chamber 742. When the actuator 721 is being pushed down to the deliver position 764 as shown in FIG. 7D, which is the end of travel in some embodiments, the mixture of the sample 710a the reagent 715a and the second reagent 725a can be delivered into the cassette or other test apparatus.

In LAMP field application, the reagent reservoir 715 can comprise dye 715a. The volume of dye 715a can be from about 1 microliter to about 500 microliters, in some embodiments. Values outside the above range are also possible. The volume of dye can be changed according to the need. For example, the volume of dye 715a can be from about 40 microliters to about 80 microliters. The second reagent reservoir 725 can comprise buffer 725a. The volume of buffer 725a can be from about 1 microliter to about 1000 microliters, in some embodiments. Values outside the above range are also possible. The volume of buffer can be changed according to the need. For example, the volume of buffer 725a can be from about 140 microliters to about 180 microliters. The sample collector (not shown) can be a sponge for absorbing urine sample, for example. The mixing chamber 742 within the adapter 740 can be a mixing and metering chamber.

During an operation in the field, an operator can use the sample collector (not shown) disposed at the distal end of the dispenser 730 to collect the sample (e.g. urine). The sample collector can collect only the necessary amount of sample needed. The necessary amount of sample can be from about 1 microliter to about 100 microliter in some embodiments. Values outside the above range are also possible. The necessary amount of sample can be changed according to the need. For example, the necessary amount of sample can be about 20 microliters to about 50 microliters in some embodiments. The operator can place the adaptor 740 onto the dispenser 730 after the sample being collected. The operator can attach the adaptor 740 of the apparatus 100 to an inlet port of a cassette, for example, a LAMP cartridge. The operator can depress the actuator 721. The movement of the actuator 721 can move the dye 715a, the buffer 725a, and the sliding plugs 716b, 726b downward until the bypass channel 772 is reached. The buffer 725a and the dye 715a are then dispensed together through the sample collector which displaces the sample along with buffer 725a and dye 715a to the mixing chamber 742 as shown in FIG. 7C.

At this point the operator can provide additional mixing by inverting the apparatus 700, but the inverting is not necessary. Dispensing through the bypass channel 772 and to the mixing chamber 742 can provide enough mixing in some embodiments. The operator can further depress the actuator 721 until the end of travel as shown in FIG. 7D where a pre-defined volume of a mixture of the sample, the buffer 725a and the dye 715a is dispensed to the cassette or the LAMP Cartridge, for example. This is the volume required to prime and fill the LAMP cartridge sample wells or chambers.

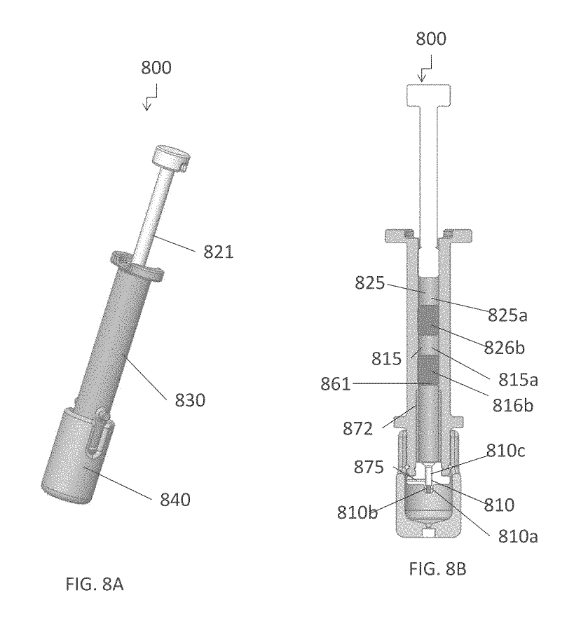

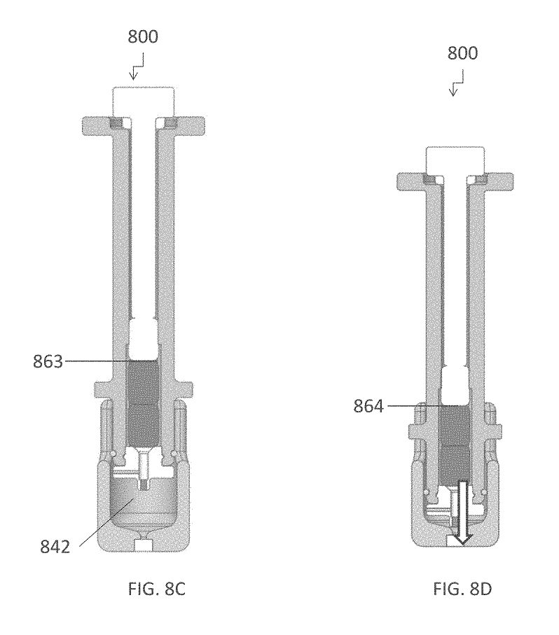

FIG. 8A schematically illustrates a perspective view of a sample handling and processing apparatus 800 comprising sliding plugs 816b, 826b, a bypass channel 872 for a blood sample in yet another embodiment. FIG. 8B schematically illustrates a section view of the sample handling and processing apparatus 800 when an actuator 821 is in the start position 861. The apparatus 800 can comprise the actuator 821 and a dispenser 830. The actuator 821 can be partially disposed within the dispenser 830 and slide back and forth along the inner side surface of the dispenser 830 axially. The apparatus 800 can further comprise an adapter 840. The apparatus 800 can comprise a sample collector 810. The sample collector 810 can be disposed at a distal end of the dispenser 830 as shown in FIG. 8B. The sample collector 810 can comprise a collection medium 810b comprising a capillary tube. The sample collector 810 can be configured to collect a blood sample 810a. The sample collector 810 can comprise a snap-on piece 810c which can attach to the distal end of the dispenser 830. In some embodiments, the apparatus 800 can further comprise a vent path 875 as shown in FIG. 8B. The apparatus 800 can comprise a reagent reservoir 815 with a pre-filled dye 815a and a second reagent reservoir 825 with pre-filled buffer 825a. The apparatus 800 can comprise a separator 816 comprising a first sliding plug 816b and a second separator 826 comprising a second sliding plug 826b. The first sliding plug 816b and the second sliding plug 826b can be disposed in serial upstream of the sample collector 810. The first sliding plug 816b and the second sliding plug 826b can separate and seal the dye 815a and the buffer 825a from ambient environment. When the actuator 821 is in the start position 861 as shown in FIG. 8B, both the first sliding plug 816b and the second sliding plug 826b can be disposed above a top end of the bypass channel 872. The dye 815a and the buffer 825a can be stored separately within the dispenser 830. When the actuator 821 is being pushed down to move or modify the first sliding plug 816b to pass the top end of the bypass channel 872, the dye 815 can flow down through the bypass channel 872. When the actuator 821 is being further pushed down to move the second sliding plug 826b to pass the top end of the bypass channel 872, the buffer 825 can flow down through the bypass channel 872 as well. When the actuator 821 is being pushed down to the dispense position 863 as shown in FIG. 8C, the dye 815a and the buffer 825a along with the blood sample 810a can be flushed out of the sample collector 810. The sample 810a the reagent 815a and the second reagent 825a can be mixed in the mixing chamber 842. When the actuator 821 is being pushed down to the deliver position 864 as shown in FIG. 8D, which is the end of travel in some embodiments, the mixture of the blood sample 10a the dye 815a and the buffer 825a can be delivered out of the apparatus 800 and into the cassette or other test apparatus.

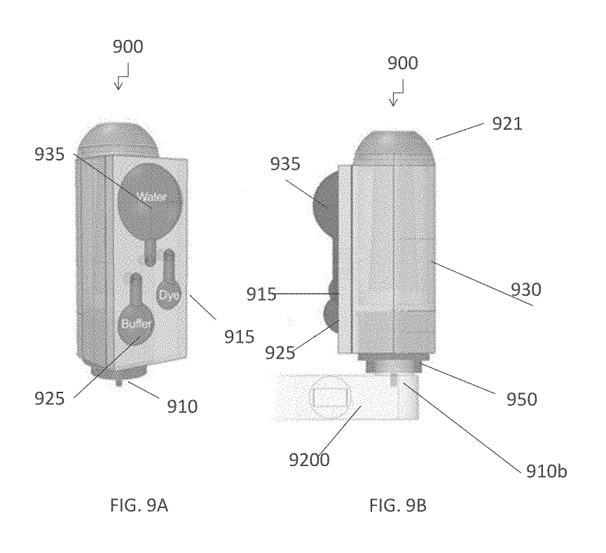

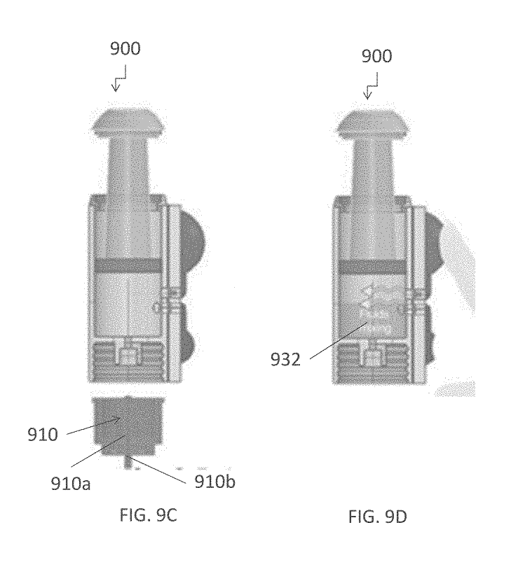

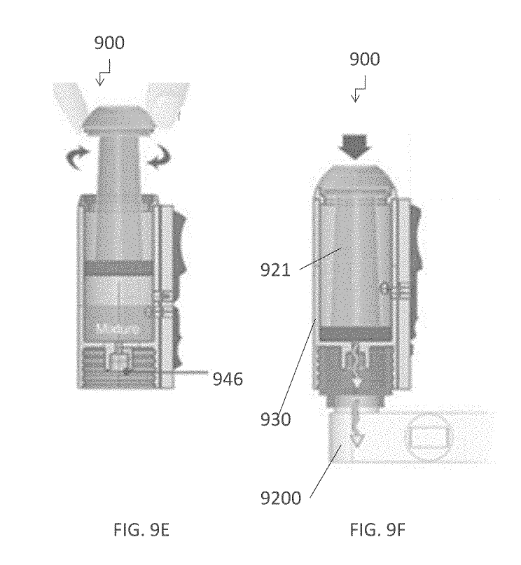

FIG. 9A schematically illustrates a perspective view of a sample handling and processing apparatus 900 comprising side blister reservoirs 915, 925 and 935 in another alternative embodiment. FIG. 9B schematically illustrates a section view of the apparatus 900 comprising side blister reservoirs 915, 925 and 935. The apparatus 900 can comprise a dispenser 930. The apparatus 900 can comprise one or more reagent reservoirs. The one or more reagent reservoirs can comprise one or more pre-filled blisters assembled or disposed to the side surface of the dispenser 930. For example, three pre-filled blisters 915, 925 and 935 are assembled or disposed to the side surface of the dispenser 930 as shown in FIG. 9A and FIG. 9B. The three pre-filled blisters 915, 925 and 935 can hold dye 915a, buffer 925a and water 935a respectively. The apparatus 900 can further comprise a sample collector 910 comprising a collection medium 910b, such as a capillary tube 910b. The sample collector 910 can be disposed at a distal end of the dispenser 930 in some embodiments. The sample collector 910 can be a snap-on piece configured to be snapped into the dispenser 930 in some other embodiments. In some alternative embodiments, the sample collector 910 can be a separate piece that is configured to be attached to the dispenser 930 and a cassette or cartridge 9200. The apparatus 900 can further comprise a connector 950, configured to connect the dispenser 930, the sample collector 910 and the cassette or cartridge 9200 together. The connector 950 can be disposed on the cassette or cartridge 9200 and the dispenser 930 in some embodiments. The connector 950 can be disposed on the sample collector 910, the cassette or cartridge 9200 and the dispenser 930 in some other embodiments. The apparatus can further an actuator 921, for example, a plunger 921 as shown in FIG. 9B.

FIG. 9C schematically illustrates a section view of the sample handling and processing apparatus 900 in a start position. The one or more reagents (e.g. dye 915a, buffer 925a and water 935a) are stored in the one or more reagent reservoirs (e.g. side blisters 915, 925 and 935) separately in a secured manner. The plunger 921 can be in a locked position in some embodiments. Then, the operator can fill the sample collector comprising a capillary tube 910b with a blood sample 910a. The operator can attach the sample collector 910 to the cartridge 9200. The operator can open the reagent reservoirs 915, 925 and 935 by pressing down the side blisters 915, 925 and 935 to open fluid flow paths. FIG. 9D schematically illustrates a section view of the sample handling and processing apparatus 900 when side blister reservoirs 915, 925 and 935 are being pressed down. The dye 915, the buffer 925 and water 935 can be mixed in the elution chamber 932 as shown in FIG. 9D. The operator can then twist to unlock the plunger 921 as shown in FIG. 9E. The apparatus900 can further comprise a separator 946 at a bottom of the elution chamber 932. The separator 946 can comprise a foil in some embodiments. The separator 946 can keep the mixture of the dye 915, buffer 925 and water 935 in the elution chamber 932 until being punctured by the capillary tube 910b of the sample collector 910.

FIG. 9F schematically illustrates a section view of the sample handling and processing apparatus 900 in a dispense position. The operator can attach the apparatus 900 to the sample collector 910. The sample collector 910 is placed downstream of the side blister reservoirs 915, 925, and 935. In some embodiments, the sample collector 910 can be disposed downstream of the elution chamber 932. The operator can actuate the plunger 921 by pressing down. The mixture of dye 915, buffer 925 and water 935 can be pushed through the capillary tube 910b of the sample collector 910. The blood sample 910a and the mixture of dye 915, buffer 925 and water 935 can be dispensed into the cassette or cartridge 9200 as shown in FIG. 9F. The apparatus 900 with one or more blister reservoirs allows for flexibility in the volume and number of reagents.

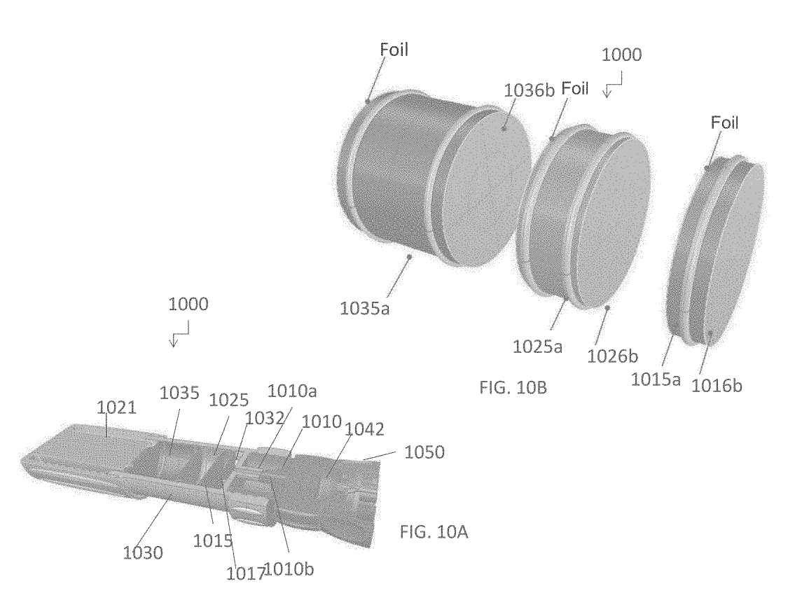

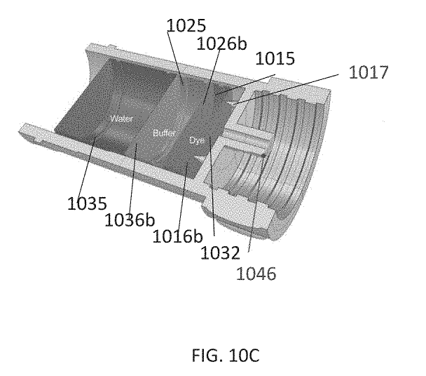

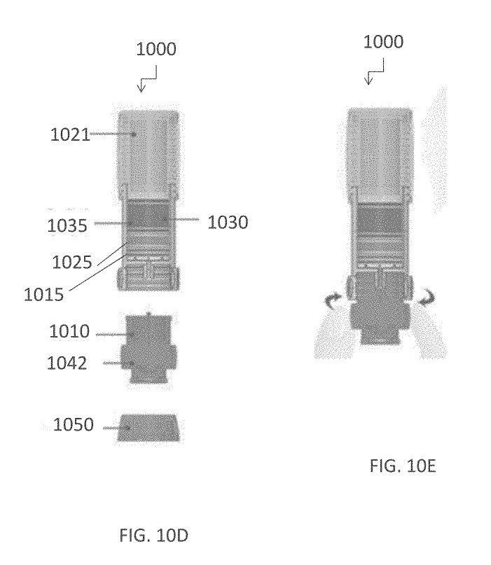

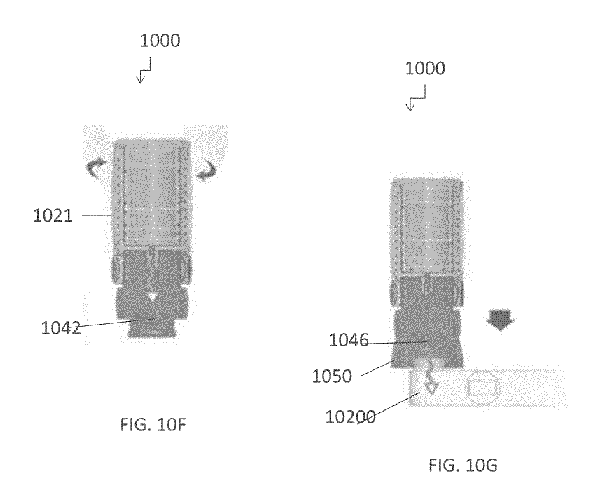

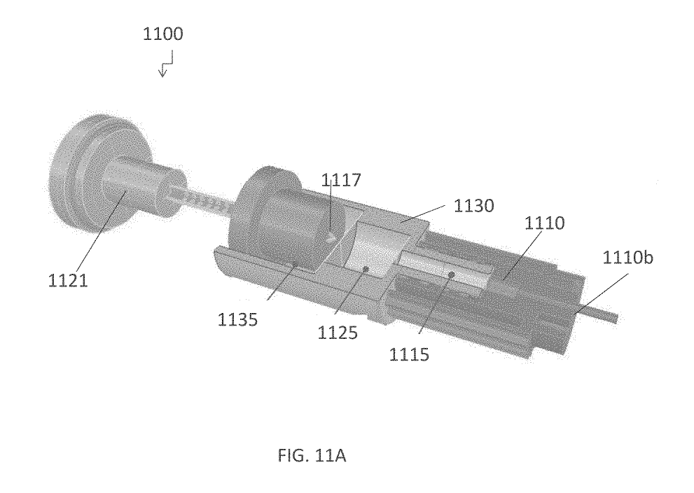

FIG. 10A schematically illustrates a perspective view of a sample handling and processing apparatus 1000 comprising inline blisters 1015, 1025 and 1035 in yet some other embodiments. FIG. 10B schematically illustrates an exploded view of the sample handling and processing apparatus 1000 comprising inline blisters 1015, 1025 and 1035. The apparatus 1000 can comprise a dispenser 1030 and one or more reagent reservoirs. The one or more reagent reservoirs can comprise one or more pre-filled inline blisters disposed within the dispenser 1030. For example, three pre-filled inline blisters 1015, 1025 and 1035 are disposed within the dispenser 1030 as shown in FIG. 10A. The three pre-filled inline blisters 1015, 1025 and 1035 can hold dye 1015a, buffer 1025a and water 1035a respectively. The apparatus 1000 can further comprise one or more separators (e.g. 1016b, 1026b, and 1036b). The apparatus 1000 can further comprise a sample collector 1010 comprising a collection medium 1010b, such as a capillary tube 1010b. The sample collector 1010 can be disposed at a distal end of the dispenser 1030 in some embodiments. The sample collector 1010 can be a snap-on piece configured to be snapped into the dispenser 1030 in some other embodiments. In some alternative embodiments, the sample collector 1010 can be a separate piece that is configured to be attached to the dispenser 1030 and a cassette or cartridge 10200. In some embodiments, the sample collector 1010 can further comprise a mixing chamber 1042 as shown in FIG. 10A. In some other embodiments, the mixing chamber 1042 can be disposed in an adapter (not shown). The apparatus 1000 can further comprise a connector 1050, configured to connect the dispenser 1030, the sample collector 1010 and the cassette or cartridge 10200 together. The connector 1050 can be disposed on the cassette or cartridge 10200 and the dispenser 1030 in some embodiments. The connector 1050 can be disposed on the sample collector 1010, the cassette or cartridge 10200 and the dispenser 30 in some other embodiments. The apparatus can further an actuator 1021, for example, a plunger 1021 as shown in FIG. 10A. The apparatus 1000 can further comprise puncture components 1017 disposed within the dispenser 1030 as shown in FIG. 10C, which can puncture and break the separators 1016b, 1026b and 1036b of the blisters 1015, 1025 and 1035 when the actuator 1021 is being pushed.

FIG. 10D schematically illustrates the apparatus 1000 comprising inline blisters 1015, 1025 and 1035 in a start position. The three pre-filled blisters 1015, 1025 and 1035 can be assembled inside the dispenser 1030. The sample collector 1010 can be used to collect a sample 1010a (e.g. blood sample). In some embodiments, the sample collector 1010 can be attached to the dispenser 1030 by screwing on as shown in FIG. 10E. In some other embodiments, the sample collector 1010 can be snapped onto the dispenser 1030. In some alternative embodiments, the sample collector 1010 can be disposed at the distal end of the dispenser 1030. The one or more reagents (e.g. dye 1015a, buffer 1025a and water 1035a) are stored separately in the inline blister reservoirs 1015, 1025 and 1035.

FIG. 10F schematically illustrates the apparatus 1000 comprising inline blisters 1015, 1025 and 1035 in a dispense position. Referring to FIGS. 10A-10F, the actuator 1021 can be screwed down to break the separators (e.g. 1016b, 1026b, and 1036b) of each inline blister reservoirs 1015, 1025 and 1035 by the puncture components 1017 disposed within the dispenser 1030. The one or more reagents (e.g. dye 1015a, buffer 1025a and water 1035a) can be pushed through the capillary tube of the sample collector 1010. The sample, and the mixture of the one or more reagents (e.g. dye 1015a, buffer 1025a and water 1035a) can be dispensed into the mixing chamber 1042 as shown in FIG. 10F.

FIG. 10G schematically illustrates the apparatus 1000 comprising inline blisters 1015, 1025 and 1035 in a deliver position. Referring to FIGS. 10A-10G, the apparatus 1000 can be attached to the connector 1050 and to the cassette or cartridge 10200 through the connector 1050. The actuator 1021 can be pushed down to deliver the mixture of the sample, and the one or more reagents (e.g. dye 1015a, buffer 1025a and water 1035a) from the mixing chamber 1042 into the cassette or cartridge 10200. For example, the actuator 1021 can be pushed down to break a separators 1046 disposed at a bottom of the mixing chamber 1042 as shown in FIG. 10G in some embodiments. In some other embodiments, the sample collector can be attached to the cartridge 10200 before attaching to the dispenser 1030, and the cartridge 10200 can comprise a seal or a valve that would preclude gravity feed until physical actuation occurs.

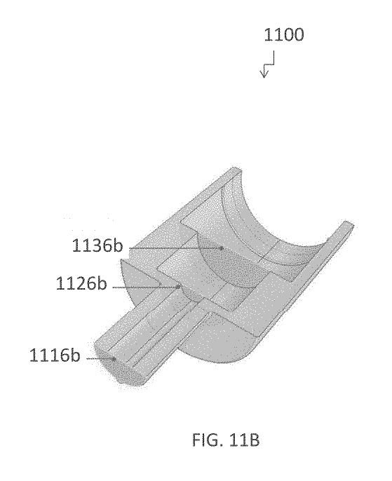

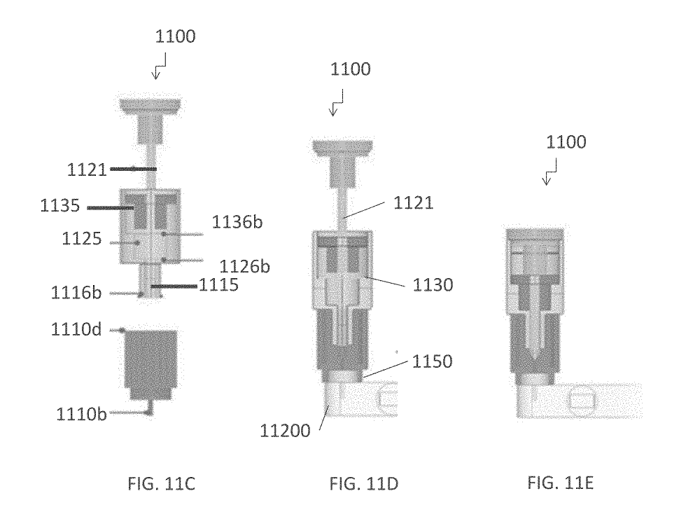

FIG. 11A schematically illustrates a perspective view of the sample handling and processing apparatus 1100 comprising a syringe-like plunger 1121 in some other embodiments. FIG. 11B schematically illustrates an exploded view of the apparatus 1100 comprising the plunger 21. Referring to FIG. 11A and FIG. 11B, the apparatus 1100 can comprise a dispenser 1130 and one or more reagent reservoirs (e.g., 1115, 1125, and 1135). The one or more reagent reservoirs can comprise one or more pre-filled chambers sealed with separators and disposed within the dispenser 1130. For example, three pre-filled chambers 1115, 1125 and 1135 are disposed within the dispenser 1130 and sealed with separators 1116b, 1126b and 1136b as shown in FIG. 11A and FIG. 11B. The three pre-filled chambers 1115, 1125 and 1135 can hold dye 1115a, buffer 1125a and water 1135a respectively. The apparatus 1100 can further comprise a sample collector 1110 comprising a collection medium 1110b, such as a capillary tube 1110b. The sample collector 1110 can be disposed at a distal end of the dispenser 1130 in some embodiments. The sample collector 1110 can be a snap-on piece configured to be snapped into the dispenser 1130 in some other embodiments. In some alternative embodiments, the sample collector 1110 can be a separate piece that is configured to be attached to the dispenser 1130 and a cassette or cartridge 11200. The apparatus can further comprise an actuator 1121, for example, a syringe-like plunger 1121 as shown in FIG. 11A. The one or more reagents (e.g., dye 1115a, buffer 1125a and water 1135a) can be dispensed through the sample collector 1110 using the plunger 1121, which is similar to a syringe. The apparatus 1100 can further comprise a puncture component 1117 disposed at a tip of the plunger 1121, which can puncture and break the separators 1116b, 1126b and 1136b of the chambers 1115, 1125 and 1135 when the actuator 1121 is being pushed.

FIG. 11C schematically illustrates a section view of the apparatus 1100 comprising the syringe-like plunger 1121. The three pre-filled chambers 1115, 1125 and 1135 can be disposed inside the dispenser 1130. The sample collector 1110 can be used to collect a sample (e.g. blood sample). In some embodiments, the sample collector 1110 can be attached to the dispenser 1130 by screwing a bottom 1110d of the sample collector 1110 onto the dispenser 1130. In some other embodiments, the sample collector 1110 can be snapped onto the dispenser 1130. In some alternative embodiments, the sample collector 1110 can be disposed at the distal end of the dispenser 1130.

FIG. 11D schematically illustrates the apparatus 1100 comprising the syringe-like plunger 1121 in a start position. The apparatus 1100 can be connected to a cassette or cartridge 11200 through a connector 1150. The connector 1150 can be disposed within the sample collector 1110 and the cartridge 11200. The plunger 1121 can be in the start position extending farthest from the sample collector 1110. The one or more reagents (e.g. dye 1115a, buffer 1125a and water 1135a) are stored separately in the chambers 1115, 1125 and 1135, upstream of the sample collector 1110.

FIG. 11E schematically illustrates the apparatus 1100 comprising the syringe-like plunger 1121 in a dispense position. Referring to FIGS. 11A-11E, once the apparatus 1100 is connected to the cassette or cartridge 11200, the operator can push down the plunger 1121 to open the separators 1116b, 1126b and 1136b of the chambers 1115, 1125 and 1136. The puncturing component 1117 at the tip of the plunger 1121 can break the separators 1116b, 1126b and 1136b. The dye 1115a, buffer 1125a and water 1135a can flush the blood sample out of the capillary tube 1110b of the sample collector 1110. The mixture of the blood sample, dye 1115a, buffer 1125a and water 1135a can be dispensed from the apparatus 1100 through the sample collector 1110 into the cassette or cartridge 11200 as shown in FIG. 11E.

The sample handling and processing apparatus 100 disclosed herein can have many variations and forms without departure from the spirit and scope of the disclosure. The disclosure further discloses a method of sample handling and processing.

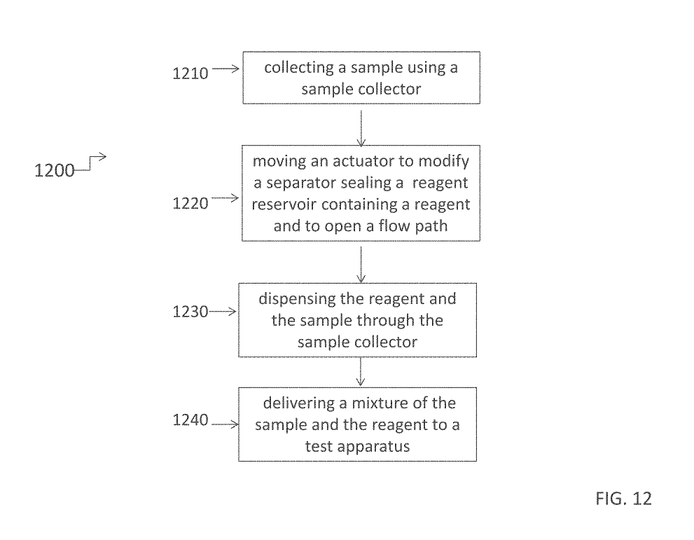

FIG. 12 is a block diagram of the method 1200 of sample handling and processing. The method 1200 can comprise collecting a sample 1210 using a sample collector. The sample collector can comprise a sample collection medium including a hard sponge, a capillary tube, a swab, etc. The sample can include blood, urine, saliva, mucous, feces, semen, tissue, cells, food, liquids, solids, gases, etc. The sample collector can be attached to a dispenser, the dispenser containing a reagent in a reagent reservoir. The sample collector can be disposed at a distal end of the dispenser in some embodiments. The sample collector can be snapped onto the dispenser in some other embodiments. The sample collector can be a separate piece in some alternative embodiments. The sample collector can be disposed into a test apparatus in some other embodiments.

The method can comprise moving an actuator to modify a separator sealing the reagent reservoir from ambient environment and to open a flow path from the reagent reservoir to the sample collector 1220. The dispenser can comprise the separator to seal the reagent. The sample collector can be placed downstream of the reagent reservoir. When the actuator is being actuated, the reagent reservoir can be modified and a flow path can be opened.

The method can comprise dispensing the sample and the reagent through the sample collector 1230. The reagent can flush the sample out of the sample collector. The sample and the reagent can be dispensed into the cassette by a movement of the actuator.

In some embodiments, the method can further comprise delivering a mixture of the sample and the reagent from a mixing chamber disposed downstream of the sample collector to the test apparatus 1240. In some other embodiments, the sample and the reagent can be dispensed into the cassette and mixed in a mixing chamber disposed with the cassette. In some alternative embodiments, the flushing action can have sufficient mixing power such that a separate mixing chamber is not necessary.

In some embodiments, the method can comprise placing the sample collector in a dispenser comprising a plurality of reagent reservoirs pre-filled with a plurality of reagents. In some other embodiments, the method can further comprise mixing the plurality of reagents in an elution chamber upstream of the sample collector. The mixture of the plurality of reagents can be pushed to flush the sample out of the sample collector. The sample along with the plurality of reagents can be dispensed into the cassette or the test apparatus.

While the present disclosure has been disclosed in example embodiments, those of ordinary skill in the art will recognize and appreciate that many additions, deletions and modifications to the disclosed embodiments and their variations may be implemented without departing from the scope of the disclosure.

A wide range of variations to those implementations and embodiments described herein are possible. Components and/or features may be added, removed, rearranged, or combinations thereof. Similarly, method steps may be added, removed, and/or reordered.

Likewise various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Accordingly, reference herein to a singular item includes the possibility that there are a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below.

Additionally as used herein, a phrase referring to “at least one of” a list of items refers to any combination of those items, including single members. As an example, “at least one of: a, b, or c” is intended to cover: a, b, c, a-b, a-c, b-c, and a-b-c.

Certain features that are described in this specification in the context of separate embodiments also can be implemented in combination in a single embodiment. Conversely, various features that are described in the context of a single embodiment also can be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described as occurring in a particular order, this should not be understood as requiring that such operations be performed in the particular order described or in sequential order, or that all described operations be performed, to achieve desirable results. Further, other operations that are not disclosed can be incorporated in the processes that are described herein. For example, one or more additional operations can be performed before, after, simultaneously, or between any of the disclosed operations. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single product or packaged into multiple products. Additionally, other embodiments are within the scope of the following claims. In some cases, the actions recited in the claims can be performed in a different order and still achieve desirable results.

What is claimed is:

1. An apparatus for sample handling and processing, the apparatus comprising:
a sample collector configured to receive a sample;
a reagent reservoir configured to hold a reagent, the reagent reservoir disposed upstream of the sample collector;
a separator disposed between the reagent reservoir and the sample collector, sealing the reagent from contamination from ambient environment; and
an actuator being movable from a start position to a dispense position to modify the separator to open a fluid flow path from the reagent reservoir to the sample collector and dispense the sample and the reagent through the sample collector.

2. The apparatus in claim 1, further comprising a dispenser, the sample collector is disposed at a distal end of the dispenser.

3. The apparatus in claim 1, further comprising a mixing chamber disposed downstream of the sample collector to mix the sample and the reagent, wherein the actuator being movable from the dispense position to a deliver position to deliver a mixture of the sample and the reagent into a test apparatus.

4. The apparatus in claim 2, further comprising an adapter, the adapter comprising the mixing chamber, and an outlet configured to deliver the mixture.

5. The apparatus in claim 1, further comprising a connector, the connector configured to mate with a test apparatus.

6. The apparatus in claim 1, wherein the sample collector comprises a sample collection medium, the sample collection medium comprising a capillary tube.

7. The apparatus in claim 1, wherein the sample collector comprises a sample collection medium, the sample collection medium comprising a porous material.

8. The apparatus in claim 1, wherein the reagent reservoir is disposed in a recessed space within the actuator.

9. The apparatus in claim 8, further comprising a puncturing component, the puncturing component is sized and shaped to match a size and shape of the reagent reservoir.

10. The apparatus in claim 1, further comprising a bypass channel, wherein the separator comprises a sliding plug, wherein the sliding plug is disposed above a top end of the bypass channel.

11. The apparatus in claim 1, wherein the separator comprises a foil sheet.

12. The apparatus in claim 1, wherein the actuator comprises a plunger.

13. The apparatus in claim 1, wherein the reagent reservoir comprises a side blister.

14. The apparatus in claim 1, wherein the reagent reservoir comprises a pre-filled chamber.

15. The apparatus in claim 1, wherein the reagent reservoir comprises a plurality of reagents, wherein the reagents comprises a plurality of reagents and wherein the separator comprises a plurality of separators.

16. The apparatus in claim 15, further comprising an elution chamber disposed downstream of the plurality of reagent reservoirs and upstream of the sample collector, wherein plurality of reagents are mixed in the elution chamber.

17. The apparatus in claim 1, further comprising a plurality of actuators.

18. A method of sample handling and processing, the method comprising:
collecting a sample using a sample collector, the sample collector attached to a dispenser, the dispenser containing a reagent in a reagent reservoir;
moving an actuator to modify a separator sealing the reagent reservoir from ambient environment and to open a flow path from the reagent reservoir to the sample collector; and
dispensing the sample and the reagent through the sample collector.

19. The method in claim 18, further comprising mixing the sample with the reagent in a mixing chamber and deliver a mixture of the sample and the reagent into a test apparatus.

20. A system for sample handling, processing and detecting, the system comprising:
a sample collector configured to receive a sample;
a sample handling and processing apparatus comprising:
a reagent reservoir configured to hold a reagent, the reagent reservoir disposed upstream of the sample collector; and
a separator disposed between the reagent reservoir and the sample collector, sealing the reagent from contamination from ambient environment;
an actuator being movable from a start position to a dispense position to modify the separator to open a fluid flow path from the reagent reservoir to the sample collector and dispense the sample and the reagent through the sample collector into a test apparatus; and
a connector configured to mate with the test apparatus; and
the test apparatus comprising an inlet to receive the sample and the reagent;
a plurality of detection chambers; and
a microfluidic channel configured to transport the sample and the reagent into the plurality of detection chambers.
